(19) United States
(12) Patent Application Publication
(10) Pub. No.: US 2015/0358262 A1
(43) Pub. Date: Dec. 10, 2015

(54) HANDHELD HYPERLINK SYSTEM

(71) Applicant: GrandiOS Technologies, LLC, Wilmington, DE (US)

(72) Inventor: John Cronin, Bonita Springs, FL (US)

(21) Appl. No.: 14/631,706

(22) Filed: Feb. 25, 2015

Related U.S. Application Data
(60) Provisional application No. 62/007,896, filed on Jun. 4, 2014.

(51) Int. Cl. H04L 12/58; G10L 15/00

(52) U.S. Cl. CPC H04L 51/046; G10L 15/00

(57) ABSTRACT

A new protocol identifier called a Hand Held Hyperlink Protocol [HHHP:/] is described, that when interpreted and parsed by the handheld operation system, can invoke an electronic device to not just display data, but also to either execute an operate or perform a function directly on the device. This capability enables new functionality of performing actions relating to a command embedded in a new form of hyperlink in accordance with settings set in an electronic device. The present invention provides improved capabilities to intelligently modify operating system functions, to initiate operations in a software application, or to control of the hardware devices, such as, a light, a speaker, a vibrator, or a camera in an electronic device.

### CROSS-REFERENCE TO RELATED APPLICATION

The present application claims the priority benefit of U.S. provisional application No. 62/007,896 filed Jun. 4, 2014 and entitled “Handheld Hyperlink System,” the disclosure of which is incorporated herein by reference.

### BACKGROUND OF THE INVENTION

1. Field of the Invention

The field of the invention relates to a system and method for invoking actions on an electronic device. More specifically, the invention relates to parsing a link and performing an action according to a command in the link according to a setting on an electronic device.

2. Description of the Related Art

It is well known that a the first part of a Universal Resource Locator (URL), (e.g., http:// or https://) is called a protocol identifier that indicates what protocol to use by system software. It is also well known that when a URL is copied from one location of an electronic document and then pasted into another location, it can be selected (“clicked on”) to arrive at the original destination. This happens because the protocol is recognized by the link controller as an indirect link (e.g., hyperlink), which then directs the opening of a browser for executing the link. The use of hyperlinks within browsers is also well-known.

Similarly, it is well-known that the data storage capacity in handheld devices (e.g., smart phones, tablets) enables vast amounts information to be stored locally on the handheld device instead of being stored remotely on the internet or cloud. Handheld devices, however, currently do not have an effective system or method for managing data files in a way that links a data file to one or more actions in a handheld device. For example, the use of a URL and hyperlinks today is limited to execution within a browser for displaying a web page. When a URL is selected (e.g., “clicked”), the browser will simply load the URL and display a webpage that addressed by the URL. The functionality provided by the URL is limited to directing a browser to display a packet of information to the user. There is a vast potential to expand the utility of handheld devices by linking an application, to a data file data using communication links that perform new active functions on handheld devices.

### SUMMARY OF THE CLAIMED INVENTION

Systems and methods for a handheld hyperlink protocol are provided. Such a new protocol identifier may be called a Hand Held Hyperlink Protocol (e.g., hhhp://). When interpreted and parsed by the handheld operation system, such a protocol identifier can invoke an electronic device to not just display data, but also to execute an operation or perform a function directly on the device. This capability enables a new functionality of performing actions relating to a command embedded in a new form of hyperlink in accordance with settings of an electronic device. As such, improved capabilities may be provided for intelligently modifying operating system functions, initiating operations in a software application, or controlling hardware devices, such as a light, a speaker, a vibrator, or a camera in an electronic device.

Various embodiments of the present invention may include methods for a handheld hyperlink protocol. Such methods may include receiving a selection of a link in a user interface on a display of an electronic device, identifying a function in the link, identifying a command in the link, and executing the command when a setting in the electronic device enables the command to initiate the function.

Some embodiments of the present invention may be implemented by a system or a non-transitory data storage medium that are configured to implement an embodiment of the invention.

### BRIEF DESCRIPTION OF THE DRAWINGS

FIG. 1 illustrates an exemplary network environment in which a handheld hyperlink system may be implemented.

FIG. 2 is a matrix that maps exemplary interactions between communication actions versus settings and functions in a handheld device.

FIG. 3 illustrates exemplary operating system settings of a handheld device that may be used in a handheld hyperlink system.

FIG. 4 illustrates exemplary software operations on a handheld device that may be used in a handheld hyperlink system.

FIG. 5 illustrates exemplary handheld hyperlinks that initiate operations on a handheld device that may be used in a handheld hyperlink system.

FIG. 6 illustrates an exemplary email prepared on a handheld device using a handheld hyperlink system.

FIG. 7 is a flowchart illustrating an exemplary method for providing handheld hyperlinks.

FIG. 8 is a matrix that maps exemplary handheld device functions to data links using functions.

FIG. 9 illustrates a mobile device architecture that may be utilized to implement the various features and processes described herein.

### DETAILED DESCRIPTION

Systems and methods for a handheld hyperlink protocol are provided. Such a new protocol identifier may be called a Hand Held Hyperlink Protocol (e.g., hhhp://). When interpreted and parsed by the handheld operation system, such a protocol identifier can invoke an electronic device to not just display data, but also to execute an operation or perform a function directly on the device. This capability enables a new functionality of performing actions relating to a command embedded in a new form of hyperlink in accordance with settings of an electronic device. As such, improved capabilities may be provided for intelligently modifying operating system functions, initiating operations in a software application, or controlling hardware devices, such as a light, a speaker, a vibrator, or a camera in an electronic device.

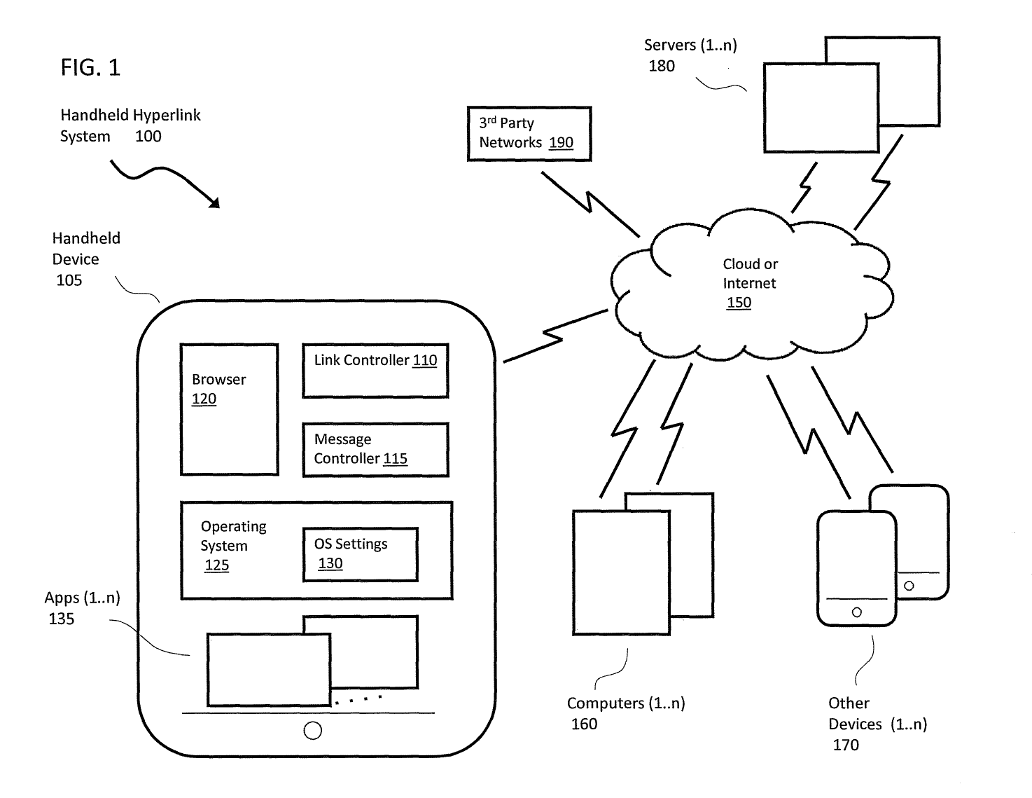

FIG. 1 illustrates an exemplary network environment in which a handheld hyperlink system may be implemented. The network environment includes a handheld device 105, cloud or internet 150, computers 160, other devices 170, servers 180, and 3rd party networks 190.

Users may use any number of different electronic handheld devices 110 computers 160, and other devices 170. Such devices may encompass general purpose computers, mobile phones, smartphones, personal digital assistants (PDAs), portable computing devices (e.g., laptop, netbook, tablets), desktop computing devices, handheld computing device, or any other type of computing device capable of communicating over communication network 150. Such devices may also be configured to access data from other storage media, such as memory cards or disk drives as may be appropriate in the case of downloaded services. Devices may include standard hardware computing components such as network and media interfaces, non-transitory computer-readable storage (memory), and processors for executing instructions that may be stored in memory.

Examples of handheld device 105 and other devices 170 include, yet are not limited to, smartphones, cellphones, Apple iPhone, Android smartphones, Samsung smartphones, iPads, notebook computers, and tablet computers. Handheld device 105 and other devices usually use wireless communication networks, such as 3G cellular, 4G cellular, or Wi-Fi, or Bluetooth when communicating with the cloud or Internet 150.

Handheld device 105 may include a link controller 110, a message controller 115, a browser 120, operating system 125 software, operating system OS settings 130, and applications 1-n 135. Handheld device communicates through the cloud or internet 150 to computers 160, other devices 170, servers 180, and 3rd party networks 190 using any communication network known in the art.

Link controller 110 and message controller 115 may be modules executable by the handheld device 105 to process handheld hyperlinks. As such, link controller 110 and message controller 115 may receive handheld hyperlink commands, identify the associated functions (e.g., by reference to a database of handheld hyperlink commands), and perform the identified functions. In the case of message controller 115, the identified function may involve processing messages to extract an embedded handheld hyperlink.

Operating system (OS) 125 is a collection of software that manages computer hardware resources and provides common services for computer programs, including applications 135. The operating system 125 is an essential component of the system software in a computer system. Applications 135 are usually developed for a specific operation system 125 and therefore rely on the associated operating system 125 to perform its functions. For hardware functions such as input and output and memory allocation, the operating system 125 acts as an intermediary between applications 135 and the computer hardware. Although application code is usually executed directly by the hardware, applications 135 may frequently make a system call to an OS function or be interrupted by it. Operating systems 125 can be found on almost any device with computing or processing ability. Examples of popular modern operating systems include Android, BSD, iOS, Linux, OS X, QNX, Microsoft Windows, Windows Phone, and IBM z/OS. Most of these (except Windows, Windows Phone and z/OS) may share roots in UNIX.

Operating system settings 130 may be a software function that opens a display that lists OS functions that may be generated upon selection of a user interface button. Such a list of OS functions may be associated with various options that allow the user to designate certain preferences or settings with respect to how certain operating system functions are performed (e.g., display preferences, wireless network preferences, information sharing, accessibility of applications to system information, such as GPS/location, notifications). Once these settings 130 are set, the operating system 125 uses the settings 130 to perform various functions, which includes functions related to execution of an application 135.

Cloud communication network 150 may be a local, proprietary network (e.g., an intranet) and/or may be a part of a larger wide-area network. Communication network 150 may comprise a variety of connected computers that may provide a set of network-based services. Such network service may be provided by real server hardware and/or by virtual hardware as simulated by software running on one or more real machines. Such virtual servers may not physically exist and can therefore be moved around and scaled up (or down) on the fly without affecting end-users (e.g., like a cloud).

Communication network 150 allow for communication between the user device 105 and other devices via various communication paths or channels. Such paths or channels may include any type of data communication link known in the art, including TCP/IP connections and Internet connections via Wi-Fi, Bluetooth, UMTS, etc. In that regard, communications network 130 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

Servers 180 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server.

Third party networks 190 may be specific types of databases that may track information regarding handheld hyperlink system 100. Third parties may include application developers and other service providers that may use such data to research and improve their own applications or services relating to handheld hyperlink system 100.

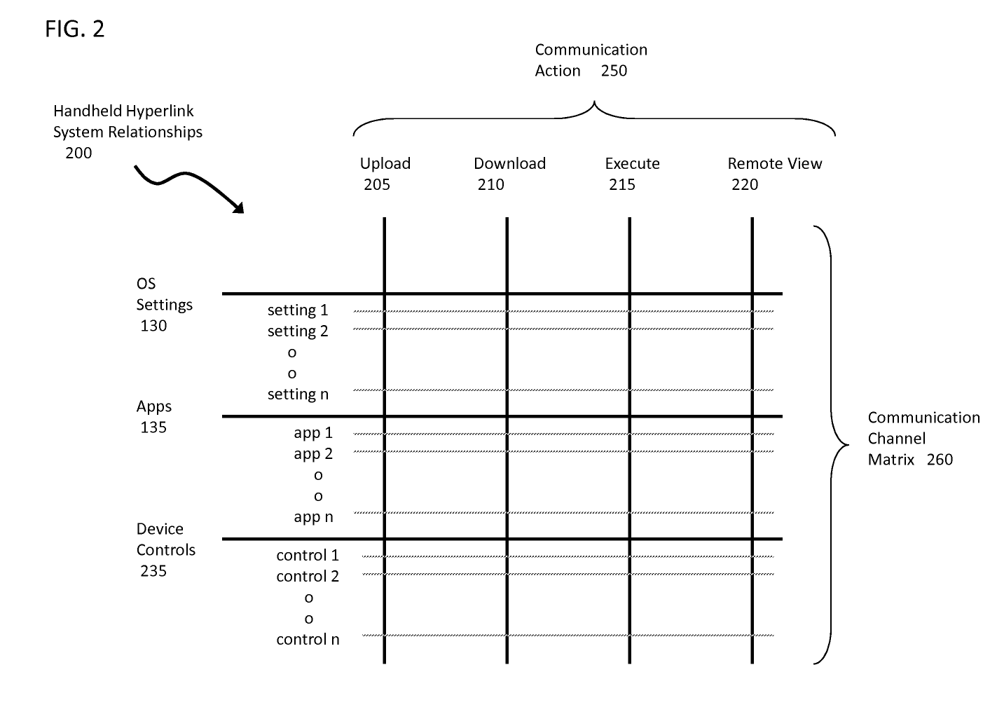

FIG. 2 is a matrix 200 that maps exemplary interactions between communication actions versus settings and functions in a handheld device. The handheld hyperlink system relationships matrix 200 includes a channel communication matrix 260 that maps operating system (OS) settings 130, applications (Apps) 135, and device controls 235 to various communication actions 250. Communication actions 250 may include upload 205, download 210, execute 215, and remote view 220. Each these individual communication actions 250 are represented by a vertical line.

OS settings 130 include a plurality of settings: setting 1, setting 2, through setting n. Each individual setting is associated with a horizontal line. Applications 135 includes a plurality of applications app 1, app 2, through app n. Each individual application (app 1-n) is associated with a horizontal line. Similarly, device controls 235 includes control 1, control 2, through control n, which are associated with horizontal lines.

Crosses of horizontal lines and vertical lines represent a possible interaction between a communication action 250 and a handheld device OS setting 130, application 135, or a device control 235. For example, a cross between setting 1 and upload 205 causes setting 1 to be used by handheld device 105 when uploading a file to the cloud or internet 150. Similarly, any of the applications 135 (app 1, app 2, through app n) may be crossed with the download 210 of a file, or device controls (control 1, control 2, through control n) may be crossed with remotely viewing 220 a video.

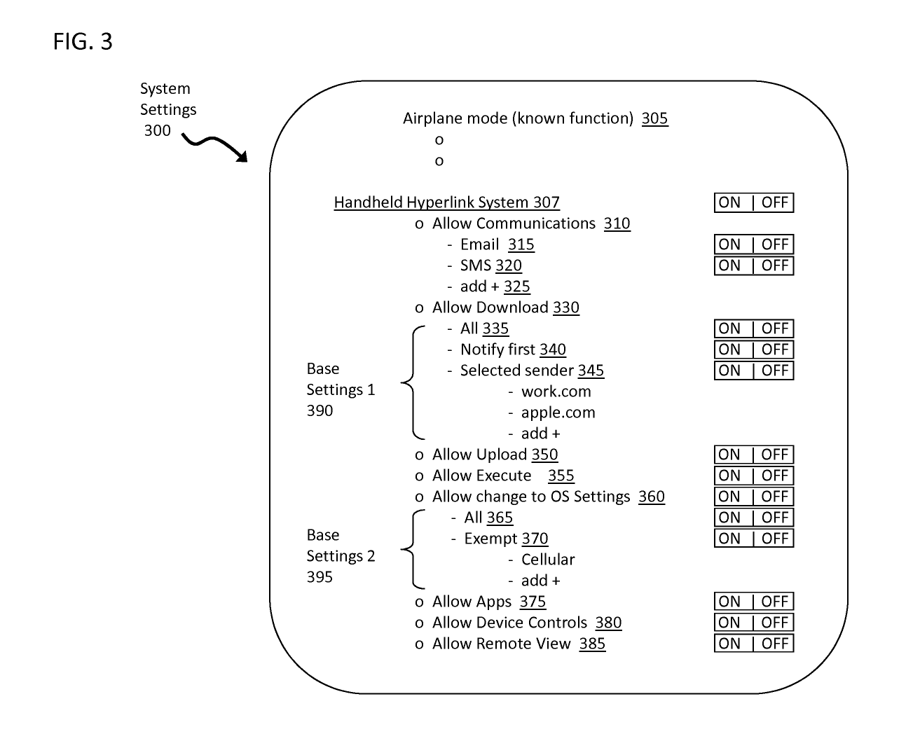

FIG. 3 illustrates exemplary operating system settings 300 of a handheld device that may be used in a handheld hyperlink system. Each of the on/off switches allow a user to turn on (enable) or turn off (disable) a function through a user interface displayed on user device 105. The switches are virtual switches presented on the user interface and may be set using a touch screen of handheld device 105.

Settings 300 may include airplane mode 305, handheld hyperlink system 307, allow communications 310, email 315, add+ 325, allow download 330, base settings 1 390, base settings 2 395, allow applications 375, allow device controls 380, and allow remote view 385. Each of these settings controls aspects of how handheld device 105 interacts with applications and communicates with other types of electronic devices through the cloud or Internet 150.

Base settings 1 390 includes options relating to download. Such options may include all 335, notify first 340, and selected sender 345. Where the option for selected sender 345 is enabled, the user may define various senders (e.g., work.com, Apple.com, and add+).

Base settings 2 395 includes options relating to allowing change to OS settings. Such options may include all 365 and exempt 370. Where the option for exempt 370 is enabled, the user may define exempt devices (e.g., cellular and add+).

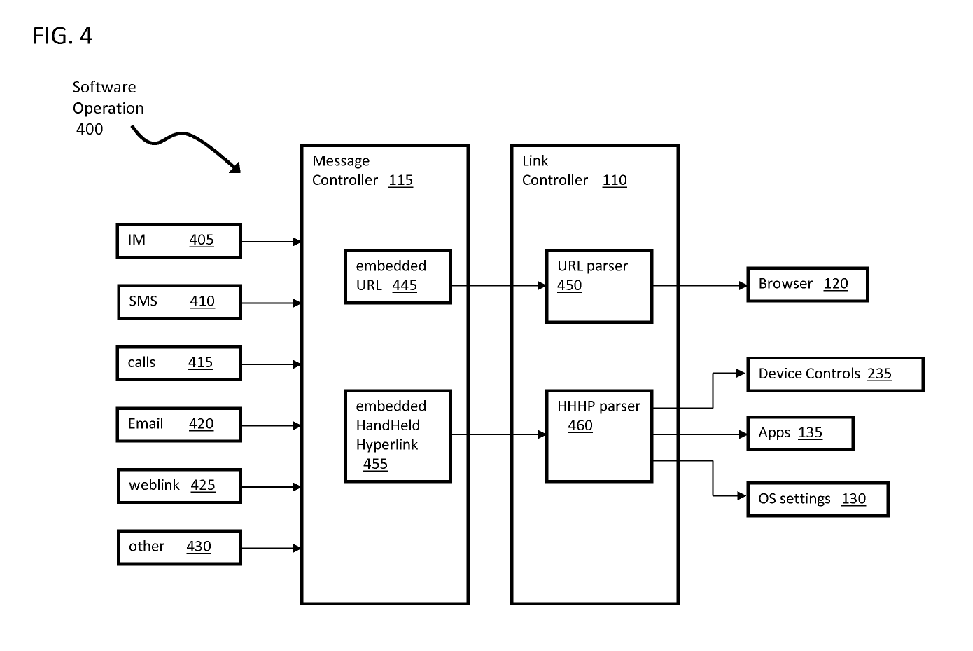

FIG. 4 illustrates exemplary software operations 400 on a handheld device that may be used in a handheld hyperlink system. A handheld hyperlink may be received via various sources, including instant messages IM 405, text messages SMS 410, phone calls 415, email 420, weblinks 425, and other sources 430. For example, an SMS text message may be received by message controller 115, which identifies any embedded URLs 445 and embedded handheld hyperlink 455. The URL or HHHP may be passed to link controller 110, which parses the respective links using URL parser 450 and HHHP parser.

Similar to the way a URL (a Universal Resource Locator) in a document or an email may be selected to initiate the action of a web browser connecting to a website and displaying a web page on a computer, a handheld hyperlink may initiate an operation according to a Hand-Held Hyperlink Protocol (HHHP). As such, URLs are associated with browser commands for opening particular webpage, and HHHPs are associated with any of a variety of commands for device controls 235, apps 135, or OS settings.

When a URL or a HHHP is selected in an email or other correspondence, the URL or HHHP will be sent to message controller 115. When the messages controller 115 receives an embedded URL 445, the message controller communicates with a URL parser in the link controller 110, and the URL parser instructs the browser 120 to load and display the webpage identified by the URL. In the instance where the message controller receives an embedded handheld hyperlink 455, the message controller communicates with a HHHP parser 460, and the link controller 110 invokes one or more actions using device controls 235, apps 135, or OS settings. The processing of handheld hyperlinks provides enhanced functionality over the functionality provided by selecting a URL because the handheld hyperlink system 100 has the ability to perform actions using applications 135 according to settings input by a user of the handheld device 105.

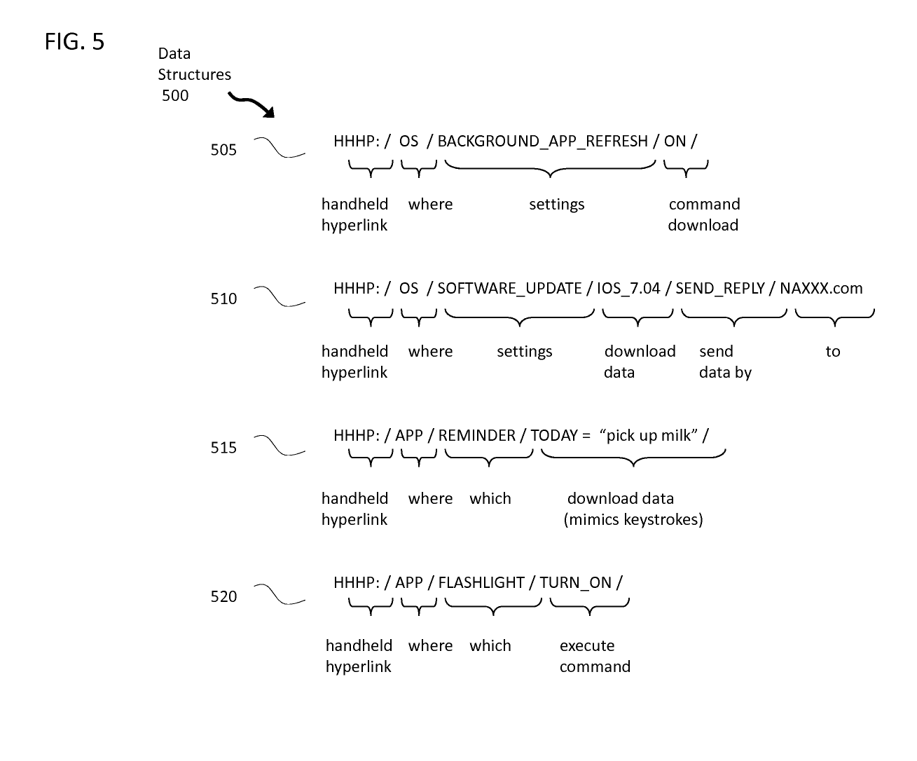

FIG. 5 illustrates exemplary handheld hyperlinks that initiate operations on a handheld device that may be used in a handheld hyperlink system. Each handheld hyperlink 505-520 includes a “handheld hyperlink” header, and a location “where” entry. Other entries in handheld hyperlinks 505-520 include a “settings” reference, a “which” entry, a “command download” action, a “download data” action, a “send data by” entry, a “to” entry, a “download data (mimics keystrokes)” action, and an “execute command” action. In certain instances, an action may initiate a software application to perform any number of functions. For example selecting a HHHP could initiate the download files of a certain file type from a shared 3rd party data base.

A first example 505 (HHHP:/OS/BACKGROUND_APP_REFRESH/ON/) is a handheld hyperlink command identified using header “HHHP.” The command is related to an operating system “OS” function affecting setting “BACKGROUND_APP_REFRESH”, that acts to “BACKGROUND_APP_REFRESH” to an “ON” state.

A second example 510 (HHHP:/OS/SOFTWARE_UPDATE/IOS_{—}7.04/SEND_REPLY/NAXXX.com) is a handheld hyperlink command identified using header “HHHP.” The command is located in the operating system “OS” that affects a setting relating to a “SOFTWARE_UPDATE” that acts to download “IOS_{—}7.04” and send a reply (“SEND_REPLY”) to email address “NAXXX.com.”

A third example 515 (HHHP:/APP/REMINDER/TODAY=“pick up milk”/) is a handheld hyperlink command identified using header “HHHP.” The command is in an application (“APP”) named “REMINDER,” and the command sends a message on a date (“TODAY”) including text “pick up milk.”

A fourth example 520 (HHHP:/APP/FLASHLIGHT/TURN_ON/) is a handheld hyperlink command identified using header “HHHP.” The command is in an application “APP” named “FLASHLIGHT” that turns on a flashlight in the handheld device using command “TURN_ON.”

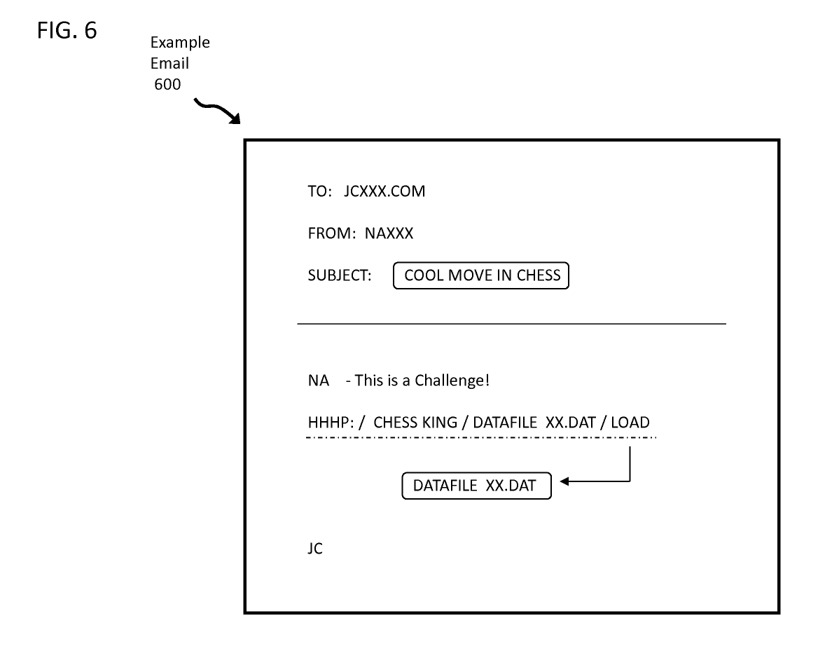

FIG. 6 illustrates an exemplary email 600 prepared on a handheld device using a handheld hyperlink system. The illustrated email 600 is addressed to “JCXX.COM,” is from “NAXXX,” and has a subject line “COOL MOVE IN CHESS.” The email includes a message “NA—This is a Challenge!” and the handheld hyperlink “HHHP/CHESS KING/DATAFILE XX.DAT/LOAD.” The arrow in the figure indicates that the hand held hyperlink links to “DATAFILE XX.DAT.”

When the embedded handheld hyperlink “HHHP/CHESS KING/DATAFILE XX.DAT/LOAD is selected, application “CHESS KING” is opened. The application “CHESS KING” then loads attached data file “DATAFILEXX.DAT” presenting user JC with a chess game challenge. User JC may then make a chess move staring at a critical point in the chess game presented to him.

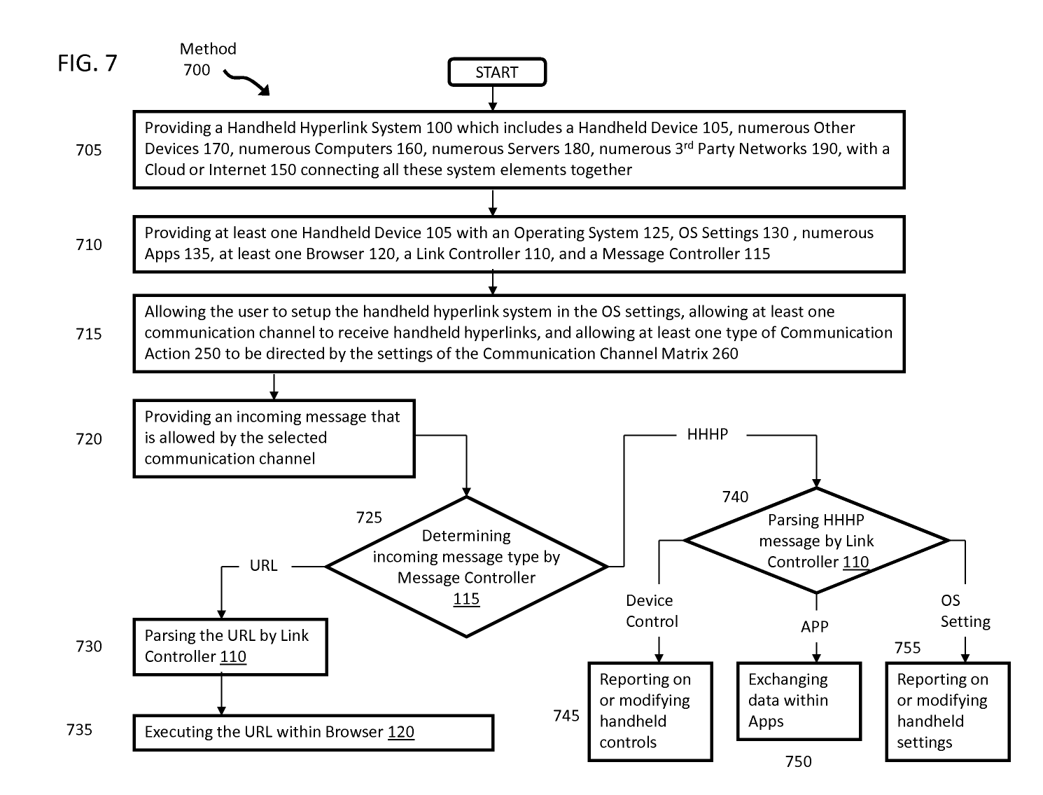

FIG. 7 is a flowchart illustrating an exemplary method for providing handheld hyperlinks. In step 705, a handheld hyperlink system 100 may be provided on a handheld device 105. The handheld hyperlink system 100 provides handheld device 105 with the ability to communicate with computers 160, other devices 170, a plurality of servers 180, and various 3rd party networks 190 through the cloud communication network 150.

In step 710, the handheld device 105 may be provided with a link controller 110, a message controller 115, at least one browser 120, an operating system 125, OS settings 130, and various applications 135. Handheld device 105 may be provided with the foregoing as native software or downloadable software for processing handheld hyperlink. A handheld device may be updated by downloading and installing new applications or operating system updates that provide handheld hyperlink processing capabilities.

In step 715, the user of a handheld device is allowed to set OS settings of the handheld hyperlink system and thereby customize how such handheld hyperlinks are processed. This allows received handheld hyperlinks to allow at least one type of communication action 250 that is directed by the settings of the communications channel matrix 260.

In step 720, an incoming message may be received at the handheld device using an allowed communication channel that has been set to receive messages. Such a message may be an internet message IM 405, a text message SMS 410, a phone call 415, an email 420, weblink 425, or be some other type 430.

In step 725, the type of the incoming message may be determined by message controller 115. Specifically, the message controller 115 may identify any embedded URLs or HHHPs. Where a URL is identified, the message may proceed to step 730 where the URL may be parsed by link controller 110 and then to step 735 where the parsed URL is executed by the browser 120. Where a HHHP is identified, the method may proceed to step 740 where the HHHP is parsed by the link controller 110. The parse HHHP may be associated with several possible actions relating to device control, apps, or OS settings. Depending on which type of action, the method may proceed to step 745 for device control actions that report on or modify handheld controls, to step 750 for app actions that exchange data within apps, or to step 755 for OS settings actions that report on or modify handheld settings.

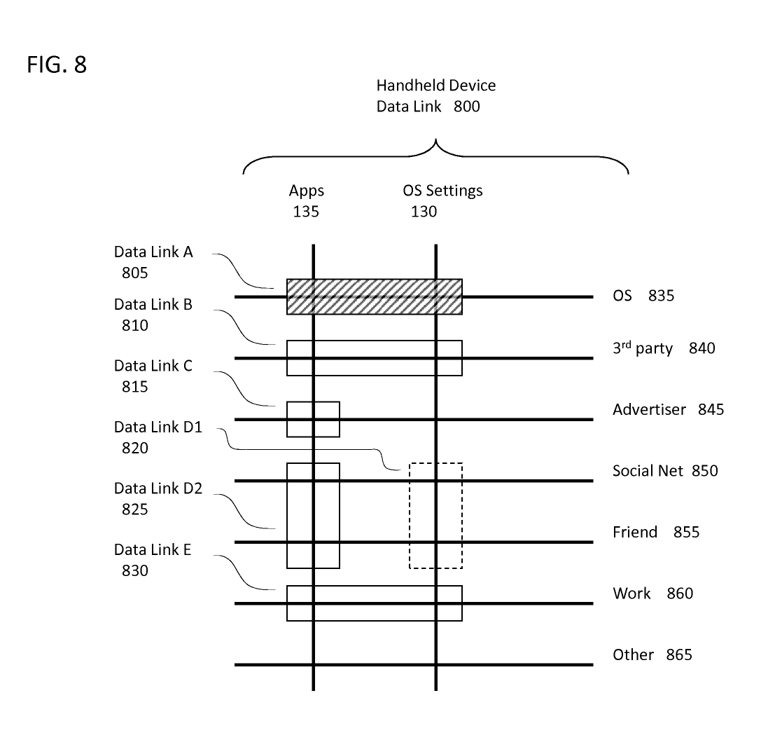

FIG. 8 is a matrix that maps exemplary handheld device functions to data links using functions. The handheld device data link 800 is a virtual interconnection matrix illustrating how applications (Apps) 135 and OS settings 130 communicate various possible data links A-E 805-830 to perform an action for the handheld device. Functions in the matrix are operating system in the figure include OS 835, 3rd party 840, advertiser 845, social net 850, friend 855, work 860, and other 865 functions.

Data link A 805 links operating system functions OS 835 to applications Apps 135 and OS settings 130. Data link B 810 links 3rd party 840 devices or applications to applications Apps 135 and OS settings 130. Data link C 815 links advertiser 845 to applications Apps 135. Data link D1 820 links OS settings to a social network 850 and to a friend 855. Data link D2 825 links applications Apps 135 to a social network 850 and to a friend 855, and data link E 830 links a work 860 application to both applications Apps 135 and to OS settings 130.

An example of a handheld hyperlink command for uploading a photo to a user folder on Facebook may be HHHP/APP/web-browser/Facebook/Alexphoto/uploadGregHfile/. This command references a specific web-browser application (Facebook) and uploading a file GregHfile to folder Alexphoto therein. Depending on settings, the photo may be uploaded using data link D2 825.

Other handheld hyperlink commands may connect to a 3rd party advertiser, such as Delta airlines using data link C 815. A HHHP command may link advertisers 845 to applications 135 to display an advertisement on a handheld device. Similarly, other functions could be performed that include, yet are not limited to, uploading a shared data file to a 3rd party database, downloading a calendar invite that opens a message in any available web-browser without using Microsoft outlook, sending a birthday greeting that plays a song, initiating a vibrator, flashing an image on a user interface, or sending a request to receive a view from a remote camera.

In certain instances, the present invention may receive HHHP protocol commands in an audio format. In these instances, the command may be received during a phone call, from an audio text message, spoken into a microphone on a handheld device, embedded in an email, or be an audio file played on the handheld device.

In certain other instances, HHHP protocol commands may be used to link to, organize, and manage data files. In certain instances, data files relating to particular HHHP hyperlinks may be migrated or copied to other files in a data store located within a handheld device. Data files organized by such HHHP hyperlinks may be organized in a matrix that maps specific HHHP hyperlinks to particular data files. The matrix may be presented on the user interface of a handheld device when performing a memory management function that may be invoked using an HHHP hyperlink command.

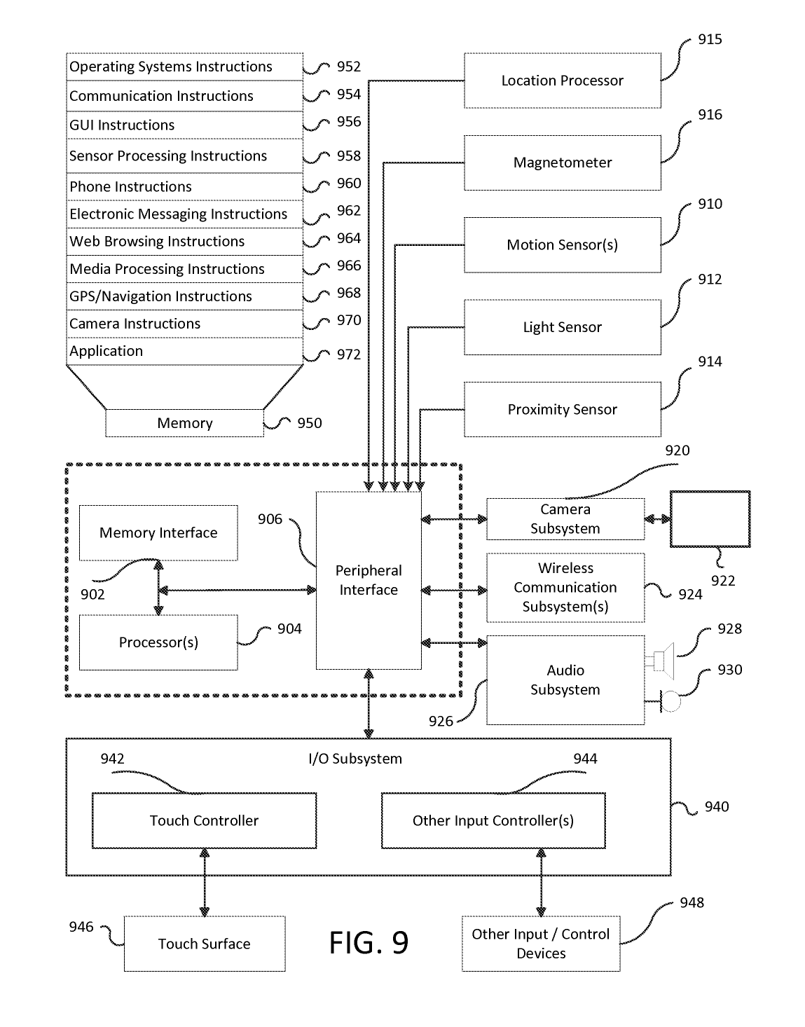

FIG. 9 illustrates a mobile device architecture that may be utilized to implement the various features and processes described herein. Architecture 900 can be implemented in any number of portable devices including but not limited to smart phones, electronic tablets, and gaming devices. Architecture 900 as illustrated in FIG. 9 includes memory interface 902, processors 904, and peripheral interface 906. Memory interface 902, processors 904 and peripherals interface 906 can be separate components or can be integrated as a part of one or more integrated circuits. The various components can be coupled by one or more communication buses or signal lines.

Processors 904 as illustrated in FIG. 9 are meant to be inclusive of data processors, image processors, central processing unit, or any variety of multi-core processing devices. Any variety of sensors, external devices, and external subsystems can be coupled to peripherals interface 906 to facilitate any number of functionalities within the architecture 900 of the exemplar mobile device. For example, motion sensor 910, light sensor 912, and proximity sensor 914 can be coupled to peripherals interface 906 to facilitate orientation, lighting, and proximity functions of the mobile device. For example, light sensor 912 could be utilized to facilitate adjusting the brightness of touch surface 946. Motion sensor 910, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 906, such as a temperature sensor, a biometric sensor, or other sensing device to facilitate corresponding functionalities. Location processor 915 (e.g., a global positioning transceiver) can be coupled to peripherals interface 906 to allow for generation of geo-location data thereby facilitating geo-positioning. An electronic magnetometer 916 such as an integrated circuit chip could in turn be connected to peripherals interface 906 to provide data related to the direction of true magnetic North whereby the mobile device could enjoy compass or directional functionality. Camera subsystem 920 and an optical sensor 922 such as a charged coupled device (CCD) or a complementary metal-oxide semiconductor (CMOS) optical sensor can facilitate camera functions such as recording photographs and video clips.

Communication functionality can be facilitated through one or more communication subsystems 924, which may include one or more wireless communication subsystems. Wireless communication subsystems 924 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 924 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 924 may include hosting protocols such that the device may be configured as a base station for other wireless devices. Communication subsystems can also allow the device to synchronize with a host device using one or more protocols such as TCP/IP, HTTP, or UDP.

Audio subsystem 926 can be coupled to a speaker 928 and one or more microphones 930 to facilitate voice-enabled functions. These functions might include voice recognition, voice replication, or digital recording. Audio subsystem 926 in conjunction may also encompass traditional telephony functions.

I/O subsystem 940 may include touch controller 942 and/or other input controller(s) 944. Touch controller 942 can be coupled to a touch surface 946. Touch surface 946 and touch controller 942 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 946 may likewise be utilized. In one implementation, touch surface 946 can display virtual or soft buttons and a virtual keyboard, which can be used as an input/output device by the user.

Other input controllers 944 can be coupled to other input/control devices 948 such as one or more buttons, rocker switches, thumb-wheels, infrared ports, USB ports, and/or a pointer device such as a stylus. The one or more buttons (not shown) can include an up/down button for volume control of speaker 928 and/or microphone 930. In some implementations, device 900 can include the functionality of an audio and/or video playback or recording device and may include a pin connector for tethering to other devices.

Memory interface 902 can be coupled to memory 950. Memory 950 can include high-speed random access memory or non-volatile memory such as magnetic disk storage devices, optical storage devices, or flash memory. Memory 950 can store operating system 952, such as Darwin, RTXC, LINUX, UNIX, OS X, ANDROID, WINDOWS, or an embedded operating system such as VXWorks. Operating system 952 may include instructions for handling basic system services and for performing hardware dependent tasks. In some implementations, operating system 952 can include a kernel.

Memory 950 may also store communication instructions 954 to facilitate communicating with other mobile computing devices or servers. Communication instructions 954 can also be used to select an operational mode or communication medium for use by the device based on a geographic location, which could be obtained by the GPS/Navigation instructions 968. Memory 950 may include graphical user interface instructions 956 to facilitate graphic user interface processing such as the generation of an interface; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes, camera instructions 970 to facilitate camera-related processes and functions; and instructions 972 for any other application that may be operating on or in conjunction with the mobile computing device. Memory 950 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 950 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer may employ to access functions supporting the API. In some implementations, an API call can report to an application the capabilities of a device running the application, such as input capability, output capability, processing capability, power capability, and communications capability.

Users may use any number of different electronic user devices, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network. User devices may also be configured to access data from other storage media, such as memory cards or disk drives as may be appropriate in the case of downloaded services. User device may include standard hardware computing components such as network and media interfaces, non-transitory computer-readable storage (memory), and processors for executing instructions that may be stored in memory.

Communication network allow for communication between the user device, cloud social media system, and third party developers via various communication paths or channels. Such paths or channels may include any type of data communication link known in the art, including TCP/IP connections and Internet connections via Wi-Fi, Bluetooth, UMTS, etc. In that regard, communications network may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

Communications network allows for communication between any of the various components of network environment may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for providing a handheld hyperlink protocol (HHHP) command, the method comprising:
receiving a message over a communication network to a mobile device; and
executing instruction stored in memory, wherein execution of the instructions by a processor:
identifies that the received message includes an embedded HHHP command,
parses the embedded HHHP command to identify a type and a function, and
performs the identified function based on the identified type.

2. The method of claim 1, wherein the message is one of an Internet message, a text message, an electronic document, and an email.

3. The method of claim 1, wherein the identified type is one of device control, application, and operating system settings.

4. The method of claim 1, wherein the identified function is one of uploading data to a remote computing device, downloading data from a remote computing device, updating the setting or another setting in the electronic device, displaying a view acquired by a remote camera, and initiating a software program application on the electronic device.

5. The method of claim 1, wherein the message is in an audio format, and wherein identifying the embedded HHHP command comprises using voice recognition software.

6. The method of claim 5, wherein the message in the audio format is one of a phone call, an audio text message, an audio attachment to an email, or an audio file stored on the mobile device.

7. The method of claim 1, wherein the embedded HHHP command further specifies content related to the identified function.

8. The method of claim 1, further comprising sharing information regarding the embedded HHHP command over the communication network with a third party.

9. An apparatus for providing a handheld hyperlink protocol (HHHP) command, the apparatus comprising:
a communication interface that receives a message over a communication network; and
a processor that executes instruction stored in memory, wherein execution of the instructions by a processor:
identifies that the received message includes an embedded HHHP command,
parses the embedded HHHP command to identify a type and a function, and
performs the identified function based on the identified type.

10. The apparatus of claim 9, wherein the message is one of an Internet message, a text message, an electronic document, and an email.

11. The apparatus of claim 9, wherein the identified type is one of device control, application, and operating system settings.

12. The apparatus of claim 9, wherein the identified function is one of uploading data to a remote computing device, downloading data from a remote computing device, updating the setting or another setting in the electronic device, displaying a view acquired by a remote camera, and initiating a software program application on the electronic device.

13. The apparatus of claim 9, wherein the message is in an audio format, and wherein identifying the embedded HHHP command comprises using voice recognition software.

14. The apparatus of claim 13, wherein the message in the audio format is one of a phone call, an audio text message, an audio attachment to an email, or an audio file stored on the mobile device.

15. The apparatus of claim 9, wherein the embedded HHHP command further specifies content related to the identified function.

16. The apparatus of claim 9, wherein the communication interface further shares information regarding the embedded HHHP command over the communication network with a third party.

17. A non-transitory computer readable storage medium having embodied thereon a program executable by a processor to perform a method for providing a handheld hyperlink protocol (HHHP) command, the method comprising:
receiving a message over a communication network to a mobile device;
identifying that the received message includes an embedded HHHP command;
parsing the embedded HHHP command to identify a type and a function; and
performing the identified function based on the identified type.
